(19) United States
(12) Patent Application Publication
(10) Pub. No.: US 2012/0288256 A1
(43) Pub. Date: Nov. 15, 2012

(54) IMAGE REPRODUCTION APPARATUS

(75) Inventors: Osamu IKEDA, Yokohama-city (JP); Norikazu YOKONUMA, Tokyo (JP)

(73) Assignee: NIKON CORPORATION, Tokyo (JP)

(21) Appl. No.: 13/558,819

(22) Filed: Jul. 26, 2012

Related U.S. Application Data
(63) Continuation of application No. 12/153,980, filed on May 28, 2008, now abandoned.
Application No. 12/153,980 is a continuation of application No. 10/206,370, filed on Jul. 29, 2002, now abandoned.
Application No. 10/206,370 is a continuation of application No. 09/610,262, filed on Jul. 5, 2000, now abandoned.
Application No. 09/610,262 is a continuation of application No. 08/938,968, filed on Sep. 26, 1997, now abandoned.
(60) Provisional application No. 60/031,868, filed on Nov. 27, 1996.

(30) Foreign Application Priority Data
Sep. 26, 1996 (JP) 8254775

(51) Int. Cl. H04N 5/93

(52) U.S. Cl. 386/241; 386/E05.028

(57) ABSTRACT

An image reproduction apparatus sequences and reproduces multiple moving pictures while eliminating linking and editing operations. A list display unit lists on a screen thumbnails corresponding to each of multiple moving pictures recorded on recording media. A selection unit selects and orders, according to selection operations, multiple thumbnails displayed by the list display unit. Based on the multiple thumbnails selected and ordered by the selection unit, a reproduction unit reproduces the moving pictures corresponding to each of the thumbnails by reproducing them in that order. A display displays moving pictures sequenced in order by the reproduction unit on a screen.

### CROSS-REFERENCE TO RELATED APPLICATIONS

This is a Continuation Application of application Ser. No. 12/153,980, filed May 28, 2008, which is a Continuation of application Ser. No. 10/206,370 filed on Jul. 29, 2002, which is a Continuation of Ser. No. 09/610,262, filed Jul. 5, 2000, which is a Continuation of Ser. No. 08/938,968, filed Sep. 26, 1997. This nonprovisional application also claims the benefit of Provisional Application No. 60/031,868, filed Nov. 27, 1996. The disclosures of the prior applications are hereby incorporated by reference herein in their entireties.

### INCORPORATION BY REFERENCE

The disclosure of the following priority application is herein incorporated by reference: Japanese Patent Application No. 8-254775, filed Sep. 26, 1996.

### BACKGROUND

1. Field of Invention

The invention relates to an image reproduction apparatus that reproduces moving pictures. In particular, the invention relates to an image reproduction apparatus that reproduces multiple moving pictures in a sequence.

2. Description of Related Art

Recently, due to the development of digital image processing using, for example, computers, image reproduction apparatus have been developed that display moving pictures on a monitor by reproducing moving picture files stored on a recording media. With such image reproduction apparatus, individual moving picture files are reproduced by selecting them one by one from a plurality of moving picture files.

In today's personal computers (PCs), it is possible to create single motion picture files by linking together multiple moving picture files. Thus, it is possible to reproduce multiple moving pictures on PCs by sequencing them. More specifically, by performing editing operations, it becomes possible, for example, to compose a single video work by appropriately linking moving picture files that have been imaged separately one scene at a time.

With such image reproduction or editing apparatus, a single moving picture file is created by linking multiple moving pictures through a series of repeated editing operations including selecting and linking the moving pictures. However, there is a problem that editing work for performing the sequenced reproduction becomes extremely complicated.

Also, such moving picture files of linked multiple moving pictures have a problem that it is not possible to make modifications to the files, with the original moving pictures included therein, once the files are initially completed. Such modifications might include changing the reproduction order. To make new modifications, it is necessary to again perform the editing operations for sequenced reproduction.

Further, there is an additional problem. Because the recording capacity of the recording media is limited, maintaining both the original and sequenced moving picture files results in the wasteful use of recording media.

### SUMMARY

In order to solve the above problems, an object of the invention is to provide an image reproduction apparatus that can entirely eliminate linking and editing operations.

A further object is to provide an image reproduction apparatus that can display multiple moving pictures by listing and correlating them.

Another object of the invention is to provide an image reproduction apparatus that can effectively use the recording media while eliminating the reiteration of sequenced reproduction operations.

A further object is to provide an image reproduction apparatus that can easily modify, when appropriate, the reproduction order of the moving pictures being sequenced and reproduced.

Another object is to provide an image reproduction apparatus that can rapidly confirm the contents of the moving pictures being sequenced and reproduced.

The image reproduction apparatus of the invention includes a list display unit that lists thumbnails on a screen. The thumbnails correspond to each of multiple moving pictures recorded on recording media. A selection unit selects in order multiple thumbnails displayed by the list display unit. A reproduction unit reproduces the moving pictures corresponding to the thumbnails selected in order by the selection unit by sequencing the moving pictures in that order. Further, a display unit displays on a screen the moving pictures sequenced in order by the reproduction unit.

### BRIEF DESCRIPTION OF THE DRAWINGS

These and other aspects and advantages of the invention will become apparent from the following detailed description of preferred embodiments when taken in conjunction with the accompanying drawings, in which:

FIG. 1 is a high-level functional diagram of one aspect of the invention;

FIG. 2 is a high-level functional diagram of another aspect of the invention;

FIG. 3 is a block diagram of a preferred embodiment of the invention;

FIG. 4 is a flow chart showing operation of the preferred embodiment of the invention;

FIGS. 5(a) and (b) show examples of thumbnail display screens according to an embodiment of the invention;

FIGS. 6(a) and (b) show thumbnail display screens, with FIG. 6(a) showing a scenario file list display, and FIG. 6(b) showing a scenario file selection;

FIGS. 7(a) and (b) also show thumbnail display screens, with FIG. 7(a) showing scenario file selection, and FIG. 7(b) showing another scenario file selection, according to an aspect of the invention;

FIGS. 8(a) and (b) show thumbnail display screens, with FIG. 8(a) and FIG. 8(b) showing aspects of removal of selections;

FIGS. 9(a) and (b) show thumbnail display screens, with FIG. 9(a) showing a scenario file selection, and FIG. 9(b) showing a thumbnail selection;

FIGS. 10(a) and (b) show thumbnail display screens showing sequenced reproductions;

FIGS. 11(a) and (b) show thumbnail display screens, with FIG. 11(a) showing a recording of sequenced reproduction, and FIG. 11(b) showing creation of a scenario file;

FIGS. 12(a) and (b) show thumbnail display screens showing rearranging of thumbnails;

FIGS. 13(a) and (b) show thumbnail display screens showing another aspect of rearranging of thumbnails; and

FIGS. 14(a) and (b) show thumbnail display screens, with FIG. 14(a) showing a standard size display, and FIG. 14(b) showing a maximum display.

### DETAILED DESCRIPTION OF EMBODIMENTS

While the invention will hereinafter be described in connection with preferred embodiments thereof, it will be understood that it is not intended to limit the invention to those embodiments. On the contrary, it is intended to cover all alternatives, modifications and equivalents that may be included within the spirit and scope of the invention as defined by the appended claims.

For a general understanding of the features of the invention, reference is made to the drawings. In the drawings, like reference numerals have been used throughout to designate identical elements.

FIG. 1 is a high-level representation of the invention. The invention includes an image reproduction apparatus including a list display unit 1. The list display unit 1 lists thumbnails on a screen which correspond to multiple moving pictures recorded on recording media. A selection unit 2 selects the moving pictures in order according to selection operations performed on multiple thumbnails displayed by list display unit 1. Multiple thumbnails are selected in order by the selection unit 2. A reproduction unit 3 reproduces the moving pictures corresponding to each of the thumbnails by sequencing them in order of selection according to reproduction selection operations. A display unit 4 displays the moving pictures that have been sequenced in order by the reproduction unit 3. The display may be on the screen. Further, the display unit 4 displays in the thumbnail display area moving pictures which have been reproduced by the reproduction unit 3 and which correspond to the thumbnails.

FIG. 2 is a further high-level representation of the invention. In FIG. 2, the image reproduction apparatus includes a reproduction information storage unit 5. Multiple moving pictures are reproduced by reproduction unit 3. Reproduction information storage unit 5 stores identifying information for identifying the multiple moving pictures. The reproduction unit 3 reproduces the multiple moving pictures corresponding to the identifying information by sequencing them. This sequencing is done according to call operations using the identifying information stored by the reproduction information storage unit 5.

According to another aspect of the image reproduction apparatus of the invention shown in FIG. 2, the reproduction information storage unit 5 stores the reproduction conditions indicating how each of the multiple moving pictures has been reproduced, in addition to storing the identifying information. The reproduction unit 3, using each of the multiple moving pictures, reproduces the reproduction conditions stored by the reproduction information storage unit 5. This is done according to call operations.

According to another aspect of the image reproduction apparatus of the invention, the list display unit 1 lists on a screen thumbnails selected by the selection unit 2 by arranging them in the order of selection. Among the thumbnails listed on the lists, two thumbnails may be selected by the selection unit 2 so as to switch the display positions of such two thumbnails. When the order of the thumbnails has been switched by the list display unit 1, the reproduction unit 3 reproduces the moving pictures corresponding to these thumbnails by sequencing them in that switched order.

According to another aspect of the image reproduction apparatus of the invention, as shown in FIG. 1, a screen operation unit 6 displays operations on a screen. The list display unit 1 lists on the screen the thumbnails selected based on the order of selection by the selection unit 2. The thumbnails are arranged in such order.

According to another aspect of the image reproduction apparatus of the invention, a thumbnail corresponding to the starting position of an operation received by the screen operation unit 6 is moved to the stopping position of that operation. When the stopping position is between two thumbnails on the screen, the moved thumbnail is displayed between the two thumbnails, thus newly rearranging the order of the thumbnails. The reproduction unit 3, when the thumbnails are rearranged in a new order by the list display unit 1, reproduces the moving pictures corresponding to those thumbnails by sequencing them in that order. Further, the operations on the screen may be drag-and-drop operations.

According to another aspect of the image reproduction apparatus of the invention, the display unit 4, with regard to the multiple moving pictures reproduced by sequencing by the reproduction unit 3, displays the frames or fields constituting the moving pictures by extracting them in a predefined interval. Thumbnails of the moving pictures are displayed as listed images.

With regard to each of the multiple moving pictures recorded on the recording media, the list display unit 1 reads and lists the images to display as thumbnails, hereinafter called “thumbnail images”. The operator selects via the selection unit 2 which moving pictures are to be sequenced and reproduced. When reproduction operations are performed, the selection unit 3 sequences and reproduces the multiple moving pictures selected in the order of selection. The display unit 4 displays on the screen the multiple moving pictures being sequenced and reproduced.

According to another aspect of the image reproduction apparatus of the invention, the moving pictures may also have sound attached. The sound may be sequenced and reproduced together with the moving pictures. Also, the sound alone may be sequenced and reproduced without reproducing the moving pictures.

According to another aspect of the image reproduction apparatus of the invention, the display unit 4 displays the moving pictures being reproduced by the reproduction unit 3 within the display areas of the thumbnails corresponding to those moving pictures. Consequently, sequenced reproduction is performed in a condition where each moving picture is listed.

According to another aspect of the image reproduction apparatus of the invention, the reproduction information storage unit 5, using the multiple moving pictures being sequenced and reproduced by the reproduction unit 3, stores the identifying information, e.g., file name, imaging date and time, and identification code, of each moving picture.

When the call operations of the identifying information are performed, the identifying information stored by the reproduction information storage unit 5 is relayed to the reproduction unit 3. The reproduction unit 3 sequences and reproduces the moving pictures corresponding to this identifying information.

According to another aspect of the image reproduction apparatus of the invention, the reproduction information storage unit 5 stores the manner in which the moving pictures have been reproduced in addition to storing identifying information. When the call operations are performed, the reproduction unit 3 reproduces the moving pictures by reproducing those reproduction conditions.

According to another aspect of the image reproduction apparatus of the invention, the list display unit 1 lists on the screen the thumbnails, selected in order by the selection unit 2, by arranging them in that order. When two thumbnails are selected by the selection unit 2, the list display unit 1 displays those two thumbnails by switching their display positions. When the order of the displayed thumbnails is switched, the reproduction unit 3 reproduces the moving pictures corresponding to these thumbnails by sequencing them in that switched order.

According to another aspect of the image reproduction apparatus of the invention, the list display unit 1 lists on the screen the thumbnails selected in order by the selection unit 2 by arranging them in that order. When the operator, for example, starts a drag operation on a thumbnail on the screen, the thumbnail corresponding to the starting point of that drag operation is moved by following the drag operation. Further, for example, when a drop action is performed between two thumbnails on the screen, the list display unit 1 inserts the moved thumbnail between those two thumbnails. As a result, the thumbnails on the screen are rearranged. When the order of the thumbnails displayed is rearranged, the reproduction unit 3 sequences and reproduces them in the newly rearranged order.

According to another aspect of the image reproduction apparatus of the invention, the frames or fields regarding the multiple moving pictures being sequenced and reproduced are extracted and displayed in a predefined interval. Consequently, the moving pictures are reproduced in fast-forward.

FIG. 3 is a block drawing of a preferred embodiment of the invention. As shown in FIG. 3, installed inside the main body 21 is an magnetooptical recording media 22. The magnetooptical recording media 22 is installed so as to provide easy installation and removal thereof. A data access component 23 is provided that reads/writes against the magnetooptical recording media 22. The data access component 23 is connected via a data compressor/decoder 24 to frame memory 25. The output of the frame memory 25 is input into a liquid crystal display (LCD) 27 via a display image generator 26.

A touch panel 28 is fixed to the LCD 27. Positional information sensed by the touch panel 28 is input into a controller 30 via a touch panel input component 29.

Control output of the controller 30 is input into the data compressor/decoder 24 and the display image generator 26. Also, the output of the controller 30 is connected to the data access component 23. The functions of the data compressor/decoder 24, display image generator 26, touch panel input component 29, and controller 30 are provided by a microprocessor 31.

The main body 21 is provided with a camera 32. The camera 32 is provided with a photographic lens 33. An imaging element 34 is placed in a position that receives the light of images of objects obtained using the photographic lens 33. The imaging element 34 can be a photoelectric converter such as, e.g., a CCD. Output signals from the imaging element 34 are input via an A/D converter 35 and a digital signal processor 36 into the frame memory 25.

The preferred embodiment of the invention relates to FIGS. 1 and 2 in that the list display unit 1 corresponds to function listing by acquiring and obtaining thumbnails by the data access component 23, data compressor/decoder 24, frame memory 25 and display image generator 26. The selection unit 2 includes the data compressor/decoder 24, touch panel 28 and touch panel input component 29. The reproduction unit 3 includes the data compressor/decoder 24, touch panel input component 29 and controller 30. The display unit corresponds to function displaying of reproduced images by the display image generator 26.

According to another aspect of the image reproduction apparatus of the invention, the reproduction information storage unit 5 includes the magnetooptical recording media 22 and the data access component 23. According to another aspect of the image reproduction apparatus of the invention, the screen operation unit 6 includes the touch panel 28 and the touch panel input component 29.

The various units of FIGS. 1 and 2 are not limited to the specific structures of FIG. 3, which relate to only one implementation of the invention.

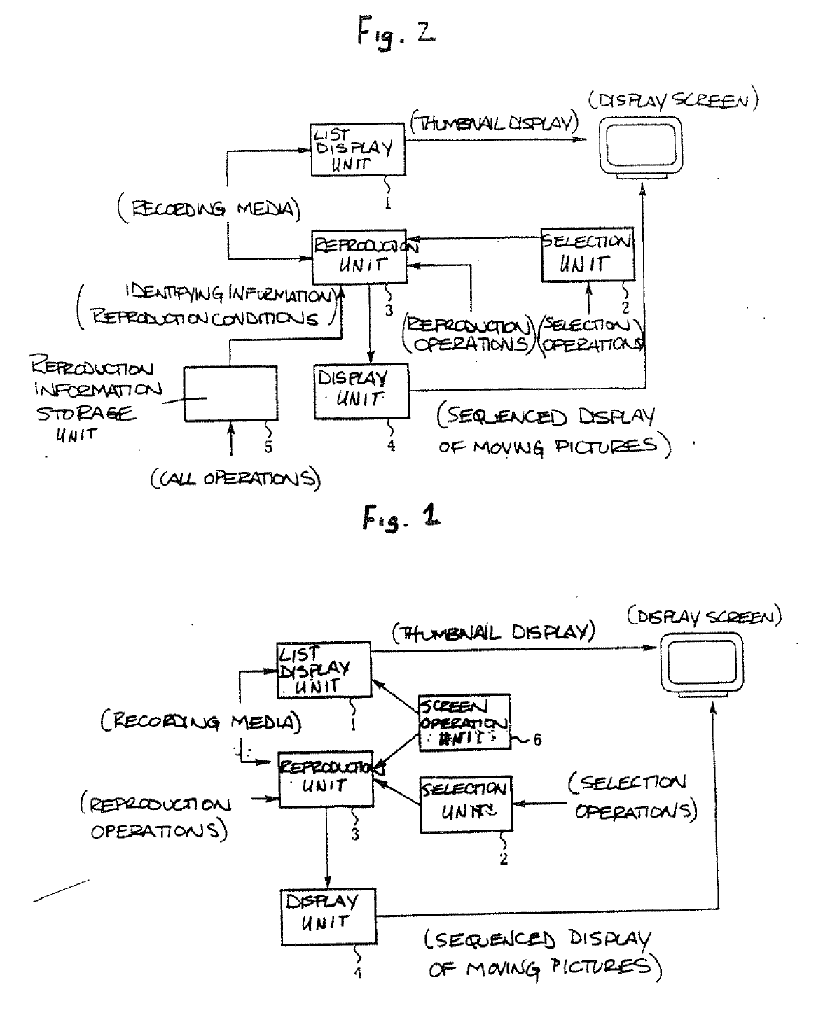

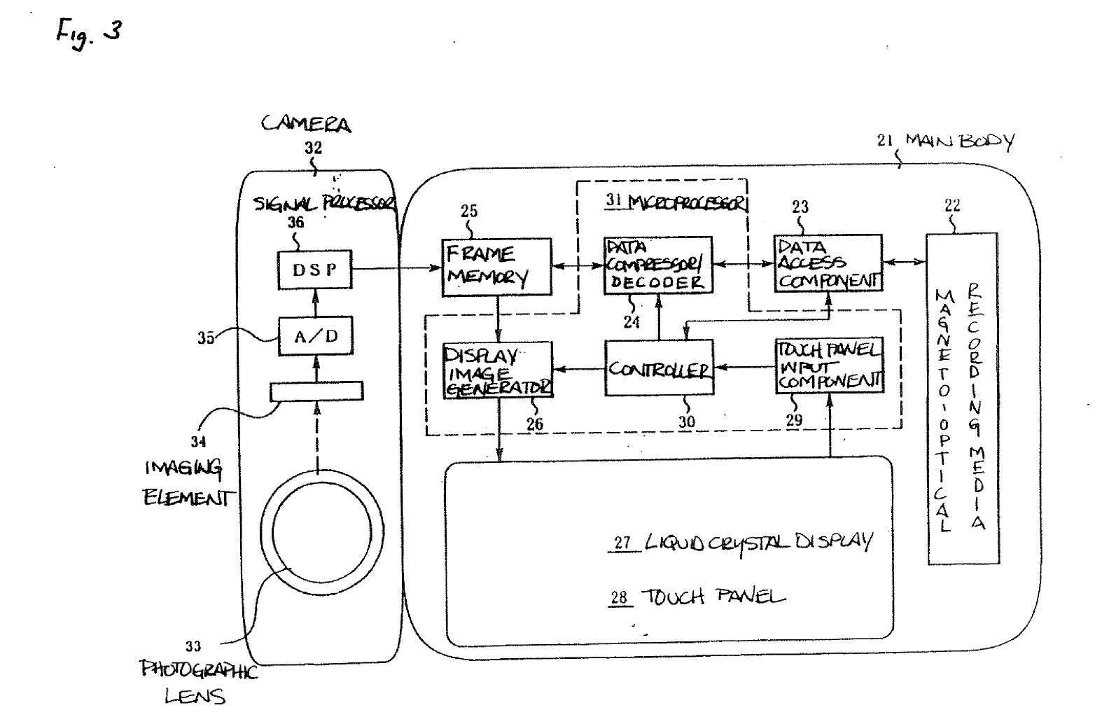

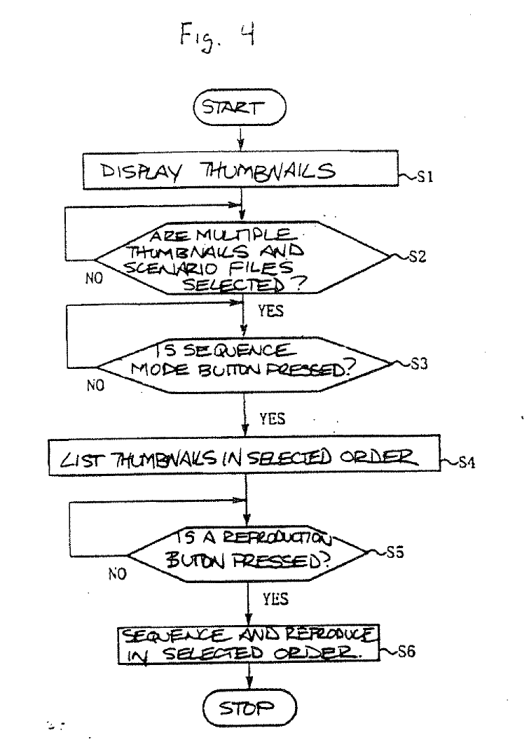

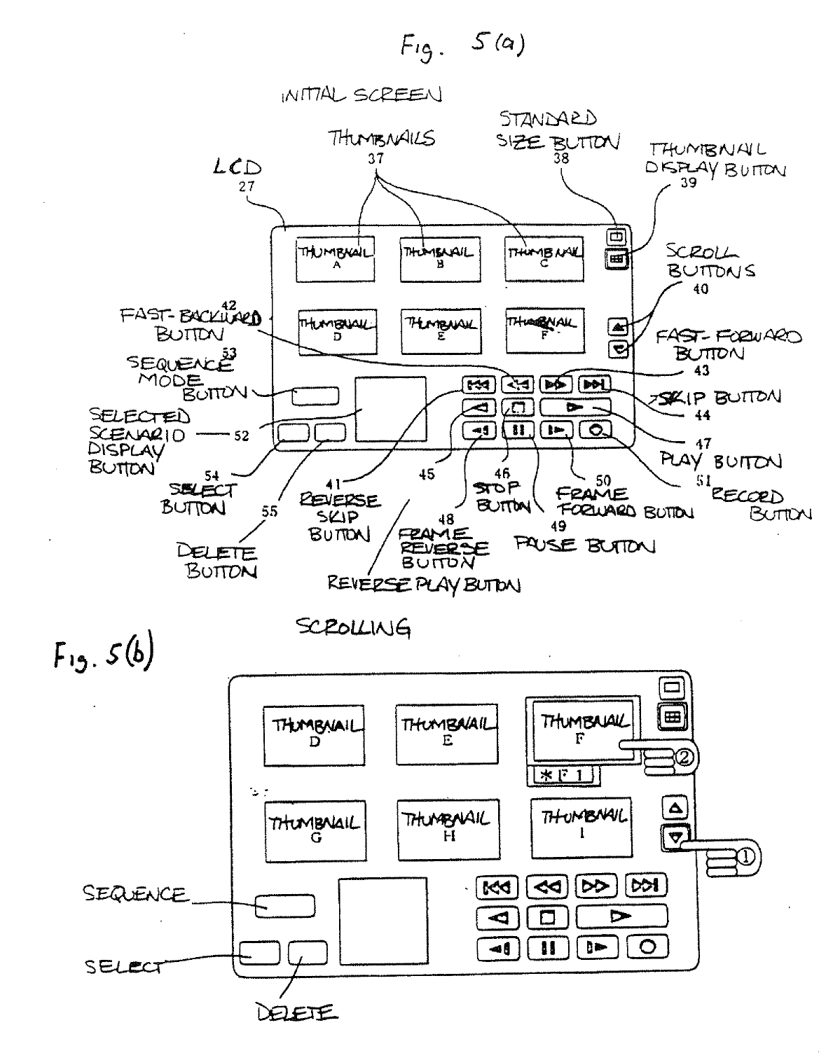

FIG. 4 is a flow chart explaining operations of the present preferred embodiment of the invention. FIG. 5(a)-FIG. 14(b) are drawings explaining the thumbnail display screens. The operations of the present preferred embodiment are explained below using the drawings.

The magnetooptical recording media 22 is installed in the main body 21. The data access component 23 reads out each leading scene of the multiple moving pictures recorded on the magnetooptical recording, media 22. The display image generator 26 creates thumbnails based on the data of these images and lists them on the LCD 27 as illustrated in step S1 of FIG. 4.

FIG. 5(a) is a drawing showing an initial screen displayed on the LCD 27. On the screen of the LCD 27 are listed the thumbnails 37. A standard size button 38 and a thumbnail display button 39 are positioned on the top right of the LCD 27. Below these buttons are positioned scroll buttons 40, for scrolling the thumbnails 37.

On the bottom right of the LCD 27 are positioned the operating buttons for reproducing records. These operating buttons for reproducing records include, from the top left, a back or reverse skip button 41, a fast-backward button 42, a fast-forward button 43, a skip button 44, a reverse reproduce (play) button 45, a stop button 46, a reproduce (play) button 47, a frame backward or reverse button 48, a pause button 49, a frame-forward button 50, and a record button 51.

On the left of the operating buttons are positioned a selected scenario display button 52, a sequence mode button 53, a select button 54, and a delete button 55. When these operating buttons are operated, the buttons are changed to be a highlighted display, and the states of the buttons are displayed. These operating buttons can be repositioned by dragging and dropping. Also, buttons that cannot be operated due to operating conditions may be displayed in half tone.

As shown in FIG. 5(b), when a scroll button 40 is touched in a first operation, the display image generator 26 scrolls the display screen. The moving pictures A-P are recorded on the magnetooptical recording media 22. The display image generator 26 displays the thumbnails corresponding to these moving pictures as thumbnails A-P. Operations performed by the operator are all performed via the touch panel 28. Touch panel 28 may utilize known GUI (Graphical User Interface) technology.

To explain further, thumbnails and operating buttons are displayed as objects on the LCD 27. The touch panel 28 and the touch panel input component 29 sense contact of the operator upon these objects. The controller 30 generates messages on the screen corresponding to the contact actions on the objects. Also, the display image generator 26 acquires those messages and performs screen modifications.

When a thumbnail is touched, the microprocessor 31 determines that the thumbnail and the moving picture corresponding to that thumbnail have been selected. Also, the display image generator 26 highlights that thumbnail. Furthermore, a scenario file is attributed to the selected moving picture that shows in a data format how that moving picture is reproduced. For example, this might include slow reproduction, fast-forward reproduction, fade-in fade-out reproduction, and size of the display area. This scenario file is appended to, for example, a file header of each moving picture file and is recorded on the magnetooptical recording media 22.

As shown in FIG. 5(b), thumbnail F is selected in a second operation and the display image generator 26 displays F1 as the scenario file. This scenario file corresponds to the identifying information and the reproduction conditions. When the highlighted thumbnail is further touched, the microprocessor 31 senses that operation, and the display image generator 26 lists the scenario file of the moving picture. The microprocessor 31 determines whether a touch operation has been performed on the list display area and the thumbnail, and recognizes which scenario file the operator has selected.

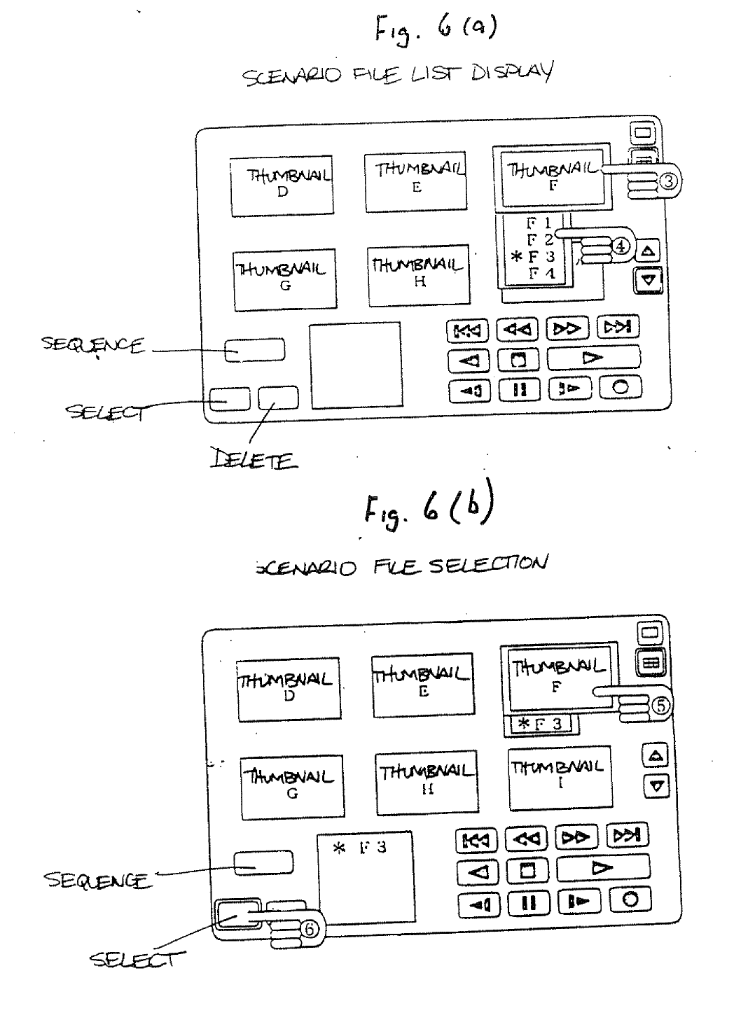

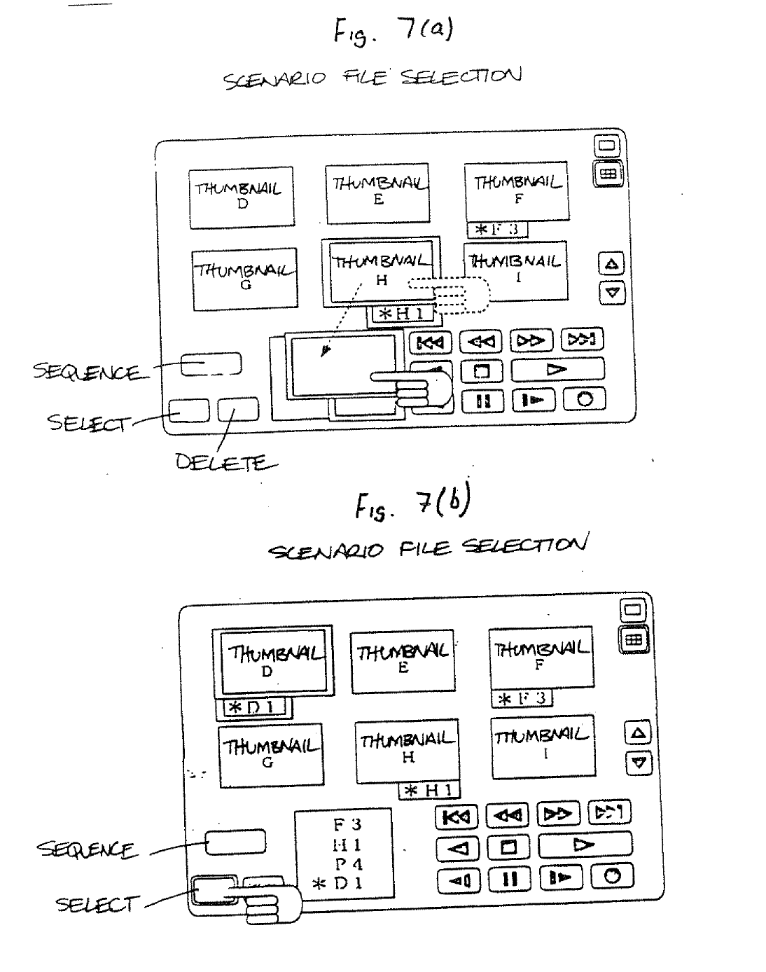

For example, as shown in FIG. 6(a), when thumbnail F is touched in a third operation, F1 to F4 are listed as the scenario files. When touch operations are performed on the scenario file list display area in a fourth operation, the display image generator 26 displays asterisks (*) moving in a downward sequence. When the touch operations are repeated, the asterisks are displayed as a single sequence. When the asterisk is displayed beside F3, as shown in FIG. 6(b), when thumbnail F is touched again in a fifth operation, the microprocessor recognizes that F3 has been confirmed as the scenario file.

Furthermore, when a touch operation has been performed on the select button 54, the microprocessor 31 recognizes that the confirmed scenario file has been selected. As a result, the display image generator 26 displays that scenario file in the selected scenario display button 52. When the select button 54 is touched in a sixth operation, the display image generator 26 displays the scenario file F3 of the moving picture F in the selected scenario file display button 52. The microprocessor recognizes that the scenario file has been selected even if the operation is performed having omitted the fifth operation.

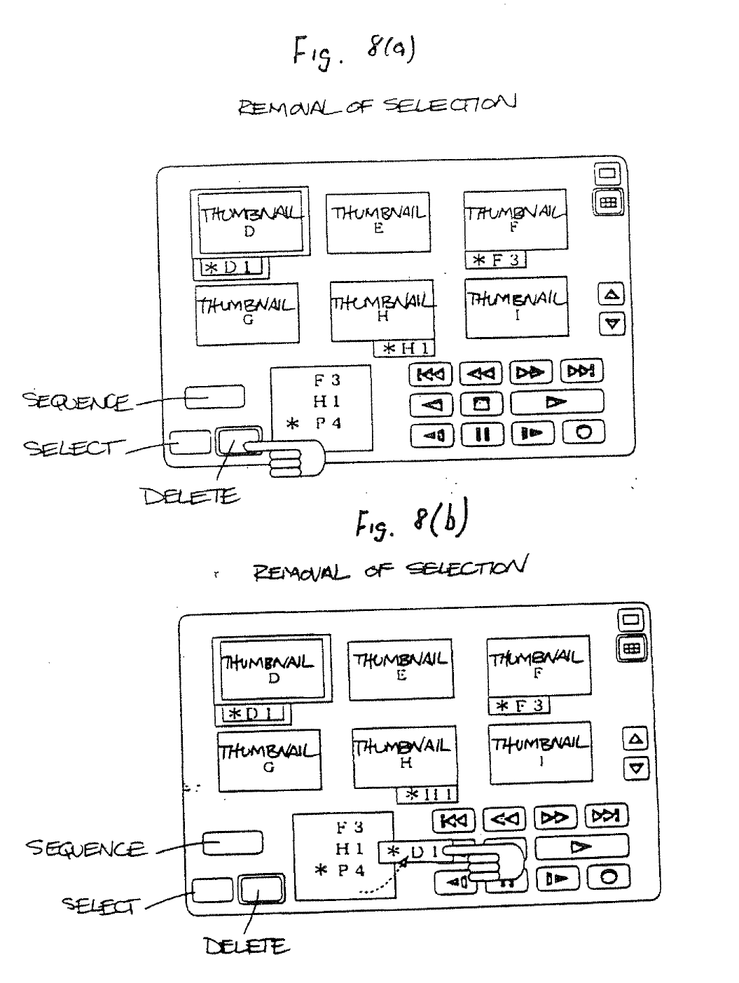

FIGS. 7(a) and 7(b) also show a selection method. As shown in FIG. 7(a), using a drag operation, e.g., touching the touch panel 28 and thereby moving thumbnail H, the display image generator 26 moves thumbnail H following the operator's finger. Next, when a drop operation, i.e., removing the finger from the touch panel 28, is performed, the microprocessor recognizes that the scenario file H1 was selected, and the scenario file H1 is displayed in the selected scenario display button 52.

The scenario file list display is positioned at the bottom left of each thumbnail for the first row of thumbnails, and is positioned at the bottom right of each thumbnail for the second row of thumbnails. Consequently, the list display of the scenario files does not overlap.

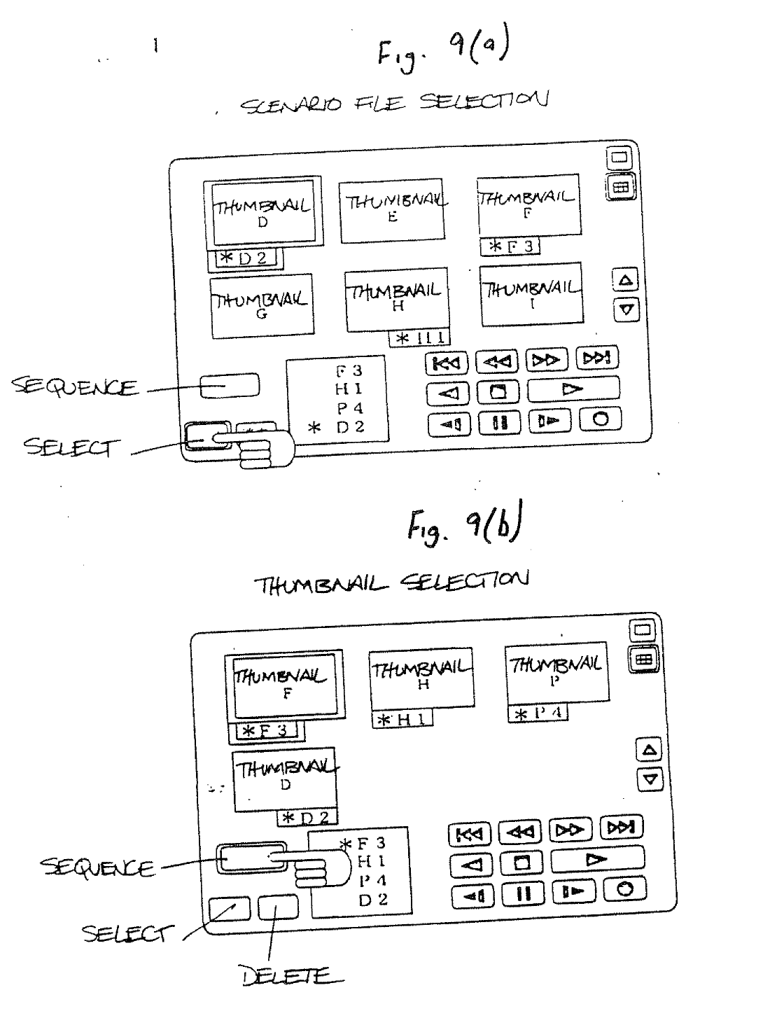

FIG. 7(b) is a drawing showing that the scenario files P4 and D1 have been selected in the same manner. In this condition, when the delete button 55 is touched, the microprocessor 31 removes the selection in the selected scenario display button 52 which has an asterisk displayed beside it. For example, D1 is removed. As shown in FIG. 8(a), the D1 scenario file is deleted from the selected scenario display button 52.

FIG. 8(b) shows another method of deletion. When the operator moves the scenario file D1 to the outside of the selected scenario display button 52 by a drag-and-drop operation, the microprocessor 31 deletes that scenario file from the selected scenario display button 52.

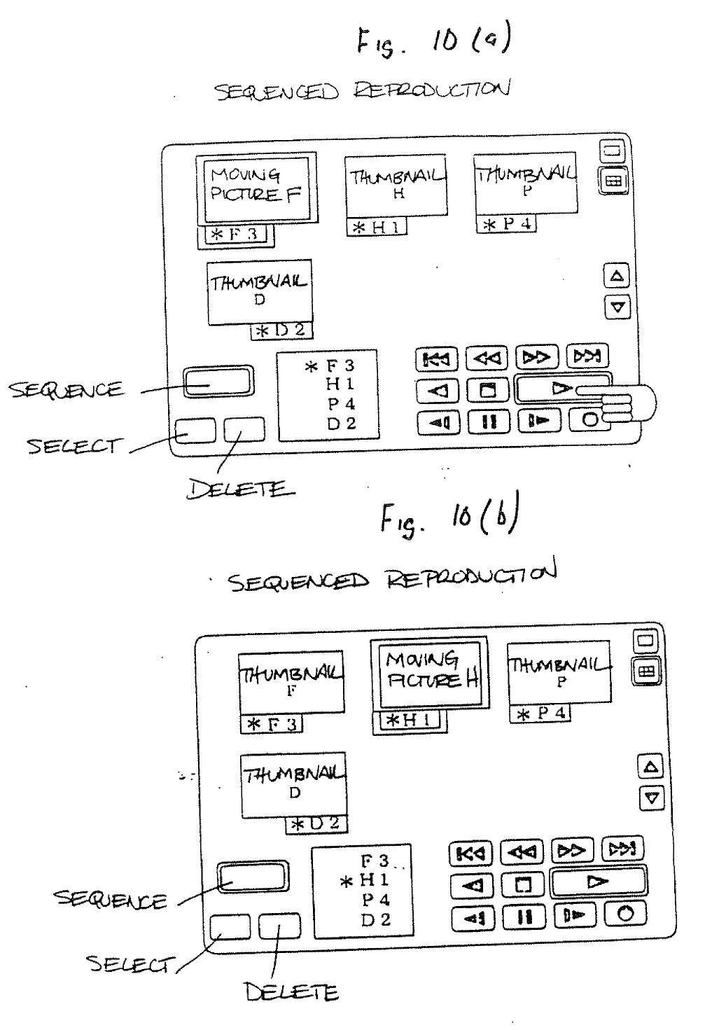

FIG. 9(a) shows that the scenario file D2 has been newly selected by a scenario file selection operation. As shown in FIG. 9(b), when the sequence mode button 53 is touched after multiple scenario files have been selected (FIG. 4, step S2 and step S3), the display image generator 26 selects only the thumbnails corresponding to the scenario files in the selected scenario display button 52 (FIG. 4, step S4). At this time, the thumbnails F, H, P and D are displayed in order.

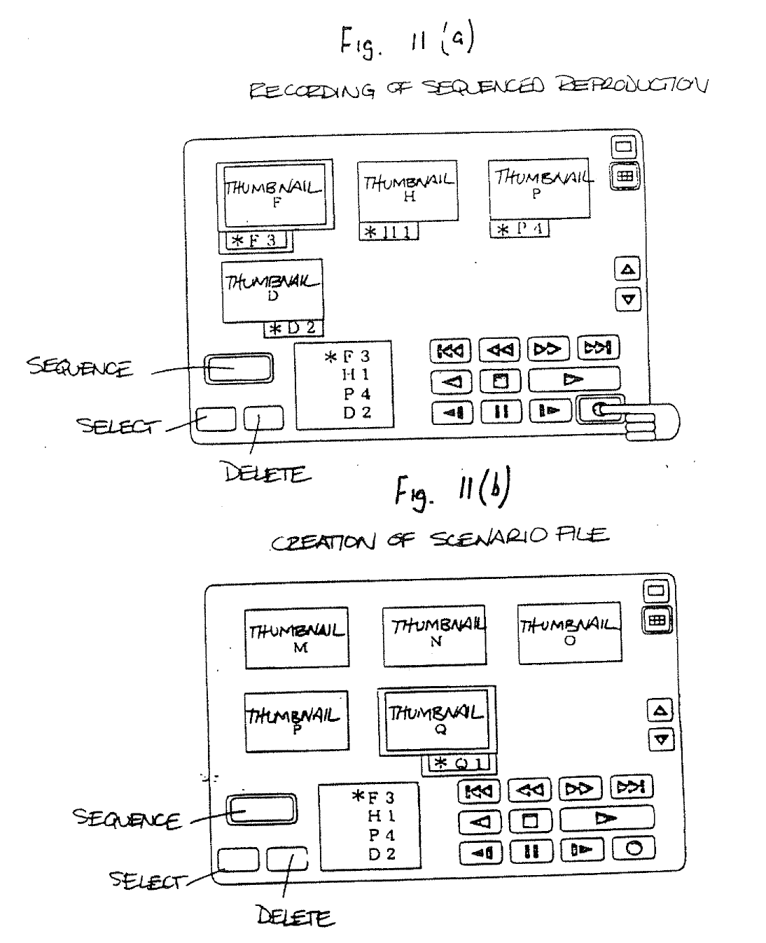

Next, as shown in FIG. 10(a), when the play button 47 is touched (FIG. 4, step S5), the moving pictures corresponding to each thumbnail are reproduced. The moving pictures are reproduced in sequence and dependent on the scenario file in the respective thumbnail display areas (FIG. 4, step S6). In the example, the microprocessor 31 reproduces the moving picture F according to scenario file F3 shown in the display area of thumbnail F.

The reproduction operations are hereinafter explained. First, the microprocessor 31 determines the moving picture F recorded on the magnetooptical recording media 22 and reads out the moving picture F therefrom. The image data is decoded by the data compressor/decoder 24 and is stored in the frame memory 25. The display image generator 26 creates the image data based on each scenario file and displays each image data in the specified position. When reproduction of the moving picture F is finished, the moving picture H is reproduced according to the scenario file H1 as shown in the display area of the thumbnail H.

In an ordered manner, the moving picture P and the moving picture D are similarly reproduced in sequence. When each moving picture has finished reproduction, it returns to the first thumbnail image. Furthermore, when the fast-forward button 43 is touched, each moving picture is reproduced in fast-forward. This operation is accomplished by the display image generator 26 performing display by decrementing the frames of the image data read out from the frame memory 25; and is done when the microprocessor 31 recognizes that the fast-forward button 43 has been touched.

Hereinafter will be explained the creation of the scenario file that records a sequenced reproduction just previously performed and reproduces the reproduction conditions of the previously performed sequenced production. When a sequenced reproduction is finished, as shown in FIG. 11(a), and the record button 51 is touched, the microprocessor 31 records as sequential data the reproduction conditions just performed. Also, the microprocessor 31 newly creates a scenario file that reproduces those reproduction conditions. At this time, the microprocessor 31 creates a scenario file recording as the new scenario file. This scenario file recording includes data such as, for example, the file name of the sequenced and reproduced moving pictures, the sequenced reproduction order, the scenario files attributed to those moving pictures, the reproduction display positions of each moving picture, and the reproduction display area.

FIG. 11(b) shows the creation of a scenario file Q1 that sequences and reproduces moving pictures contained in the thumbnail display area in the order of F, H, P and D, according to each scenario file F3, H1, P4 and D2, respectively. The scenario file Q1 is stored on the magnetooptical recording media 22 via the data access component 23. Also, as shown in FIG. 11(b), the display image generator 26 displays the thumbnail Q by adding it to the very last thumbnail display screen on the LCD 27. At such time, the image used in thumbnail Q uses the same image as thumbnail F. Thereafter, when the scenario file Q1 is selected and the play button 47 is pressed, the microprocessor 31 reads out the scenario file Q1 from the magnetooptical recording media 22 and reproduces the reproduction conditions according to that scenario file. Here, the conditions of FIGS. 10(a) and 10(b) are reproduced, and sequenced reproduction of the moving pictures F, H, P and D is performed.

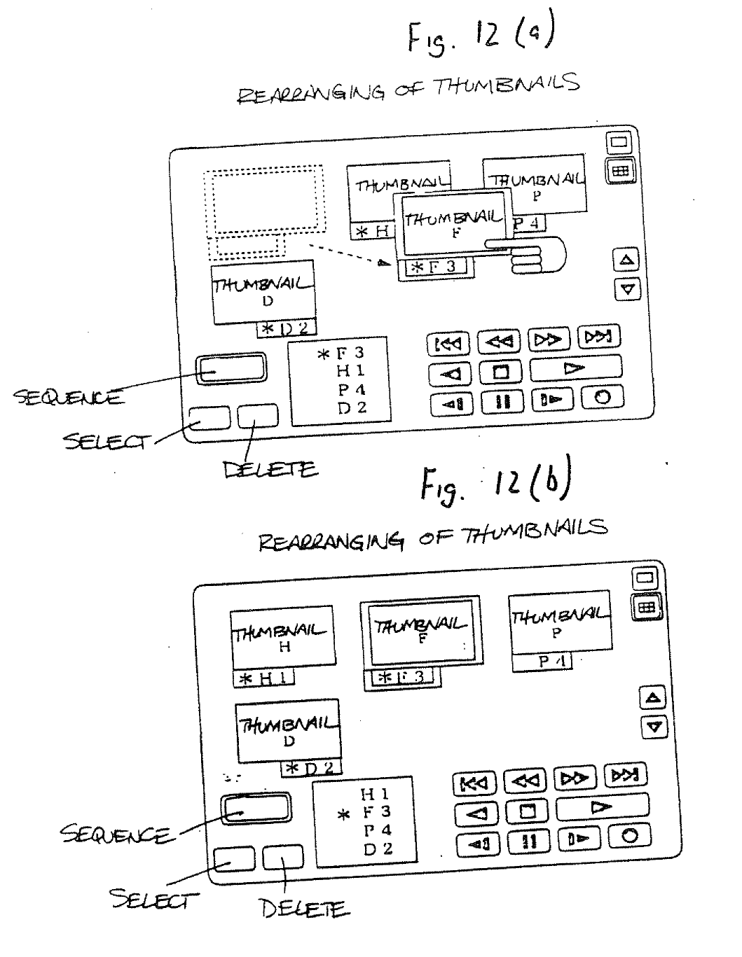

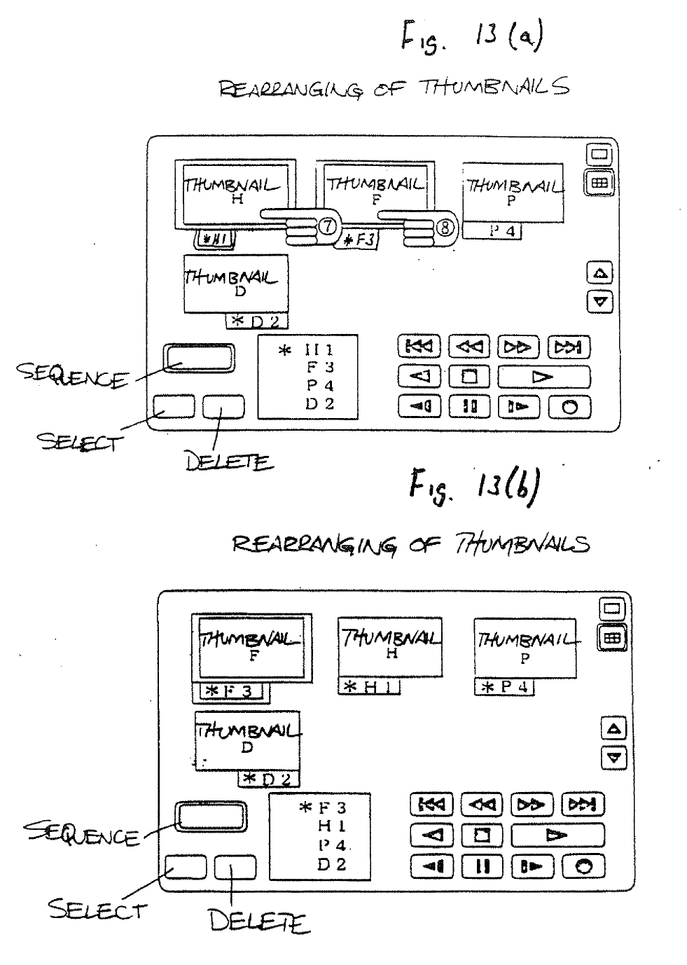

Hereinafter, rearranging of the thumbnails will be explained. In FIG. 9(b), when the operator wishes to rearrange the thumbnails that are selected and displayed and moves the thumbnail by a drag-and-drop operation to an insert position, all the thumbnails are rearranged and displayed. As shown in FIG. 12(a), a user can insert the thumbnail F between the thumbnail H and the thumbnail P. As a result, the thumbnails are rearranged as shown in FIG. 12(b). At this time, the microprocessor 31 performs display processing including rearranging the thumbnails by removing the thumbnail corresponding to the touched position, for example thumbnail F, moving the thumbnail F following the drag operation of the operator, and inserting the thumbnail F into the dropped position between, for example, thumbnail H and thumbnail P.

In this condition, when the play button 47 is touched, the microprocessor 31 performs sequenced reproduction in the order of moving picture H, moving picture F, moving picture P, and moving picture D. The microprocessor 31 identifies the display positions of the thumbnails and the order in which the moving pictures are sequenced and reproduced. As a result, when the display positions of the thumbnails change, the reproduction order of the moving pictures also changes. Furthermore, when the record button 51 is touched, the microprocessor 31 newly creates a scenario file that reproduces this condition.

The thumbnails may also be switched with an operation shown in FIG. 13(a). When the thumbnail H and the thumbnail F are quickly touched twice, corresponding to double-clicking of a mouse, (operations 7 and 8), the microprocessor 31 recognizes that the user has selected that the two thumbnails, thumbnail H and thumbnail F, be switched. Next, the display image generator 26 displays the two selected thumbnails by switching the display positions as shown in FIG. 13(b).

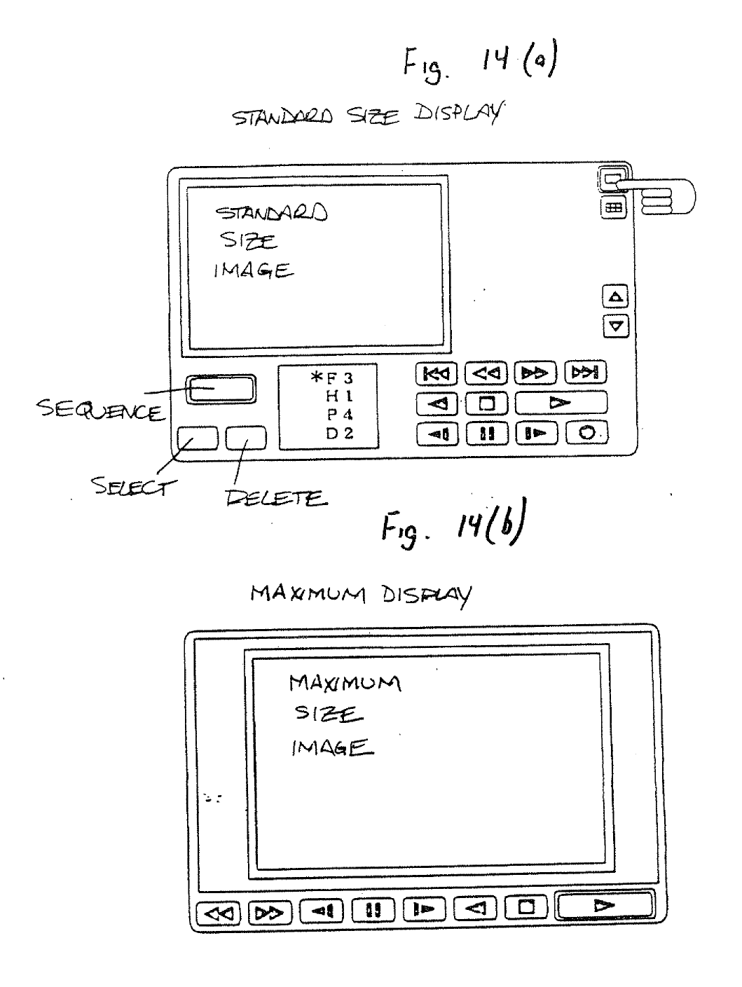

Also, when the standard size button 38 is touched, the display area of the selected thumbnail changes and is displayed larger. An example of such modified display format is shown in FIG. 14(a). To explain, when the standard size button 38 is touched, the display image generator 26 displays the image display area by making it larger. This operation creates an image of a new size, for example, by magnifying the pixel count by an integer, dividing by a fixed block unit, and averaging. As shown in FIG. 14(b), the reproduction display area may be made as large as possible during sequenced reproduction.

According to the invention, the main body 21 is equipped with a camera 32 having an imaging element 34. The imaging element 34 photoelectrically converts images obtained via a photographic lens. The resulting signals are converted into digital signals by an A/D converter 35.

The digital signal processor 36 performs signal processing such as, for example, white balance adjustment, gamma correction and pixel interpolation. After signal processing, the resulting signal is compressed by the data compressor/decoder 24 via the frame memory 25. The compressed data is recorded on the magnetooptical recording media 22 via the data access component 23. Additionally, the photographic image data in the frame memory 25 is output via the display image generator 26 to be displayed for monitoring on the LCD 27.

In this manner, with the image reproduction apparatus of the present preferred embodiment of the invention, the reproduction conditions of the sequenced reproduction can be readily modified by rearranging the thumbnails and by using scenario files. For example, given certain conditions of a thumbnail-selected display screen, the operator can modify arbitrarily the order of the sequenced reproduction of the moving pictures by rearranging the thumbnails with easy operations. Also, if a scenario file is registered once, modifications including adding and deleting moving pictures can be performed easily. Further, because the scenario file includes data indicating, for example, the file name and reproduction conditions, the recording media can be used effectively. This is because the necessary file capacity is reduced.

In the present preferred embodiment, thumbnails are created automatically for leading scenes (i.e., the first or initial scene) of moving picture files, but the invention is not limited to this. For example, the operator may select any arbitrary scene of a moving picture file and display that as the thumbnail. Furthermore, the scenario files were recorded on the magnetooptical recording media 22 along with the moving pictures. However, such description is not limiting since they may also be recorded on separate recording media. In the present preferred embodiment, the file names were used as the identifying information, but the invention is not limited to such. Any information for specifying the moving pictures, such as an address, may be used.

Also, in the present preferred embodiment, a touch panel was used as the operation input component, but the invention is not limited to that. For example, a separate operating button may be provided or a mouse may be used.

Further, in the present preferred embodiment, the thumbnails were displayed arranged in order horizontally from the top left of the screen and were sequenced and reproduced in that order. However, the invention is not limited to that, and the manner of arrangement and the direction of arrangement may be established freely.

Also, in the present preferred embodiment, a magnetooptical recording media was used. However, the invention is not limited to that, since, for example, magnetic recording media, optical recording media, or semiconductor recording media may be used. The recording media also need not be removable from the main body 21, although that is preferred.

The main body 21 can be permanently attached to the camera 32 or could be a separate, detachable element. In particular, the display 27 and touch panel 28 (or other input selection device) could be a PC monitor that is separate from the camera.

With the image reproduction apparatus of the invention, moving pictures can be sequenced and reproduced in order by only selecting the first moving picture. Consequently, the operator can entirely eliminate complicated repetitions of sequentially performing the selecting and linkage editing of the moving pictures. When performing the selection and sequenced reproduction of the first moving picture, the rest of the moving pictures are sequenced and reproduced automatically. As a result, the user is able, for example, during presentations to focus thought exclusively on explanation of the presentation without being distracted by the operations of the apparatus.

According to another aspect of the image reproduction apparatus of the invention, multiple moving pictures can be sequenced and reproduced in the thumbnail display areas corresponding to those moving pictures. Consequently, movements of the multiple moving pictures can be displayed by listing and correlating them.

According to another aspect of the image reproduction apparatus of the invention a reproduction information storage unit stores the identifying information and reproduction conditions of the sequenced and reproduced moving pictures. Consequently, if the scene is stored once, the operator can call up that scene at any time and reproduce the scene correctly. In particular, when trying to repeat a scene, the invention is extremely effective since the scene can be repeated performing again the sequenced reproduction operations. Also, since the identifying information and reproduction conditions include such information as, for example, the file name, the file capacity can be kept small. Consequently, there is no new image file created after linking and editing, as in conventional image reproduction apparatus. As a result, the recording media can be used effectively.

According to another aspect of the image reproduction apparatus of the invention, the order of the sequenced reproduction can be modified by switching the thumbnails or by rearranging the thumbnails. With conventional image reproduction apparatus, once an image file for a one time sequenced reproduction is created, its contents become unmodifiable. However, with the image reproduction apparatus of the invention, the order of the moving pictures sequenced and reproduced can be modified by easy operations.

According to another aspect of the image reproduction apparatus of the invention, because the sequenced and reproduced moving pictures can be reproduced in fast-forward, the operator can quickly understand their contents. Thus, with an image reproduction apparatus according to the invention, the order of sequenced reproduction can be modified appropriately. Moreover the recording media can be utilized effectively.

While the invention has been described in conjunction with specific embodiments thereof, it is evident that many alternatives, modifications and variations may be apparent to those skilled in the art. Accordingly, the preferred embodiments of the invention as set forth herein are intended to be illustrative, not limiting. Various changes may be made without departing from the spirit and scope of the invention as defined in the following claims.

What is claimed is:

1. A digital image data recording and reproducing apparatus comprising:
a random accessible memory medium;
a recording unit configured to access the random accessible memory medium to record on the memory medium a plurality of data files each of which has a moving digital image data and to reproduce the moving digital image data from the random accessible memory medium; and
a processor electrically connected to the recording unit, the processor configured to produce a plurality of still digital image data, which respectively represent a plurality of moving digital image data, and reproduction information, which indicates a reproduction order of a plurality of user selected still digital image data and corresponding plurality of selected moving digital image data, so that the plurality of still digital image data and the reproduction information are displayed simultaneously on a display unit, the processor configured to cause the recording unit to record the reproduction information on the random accessible memory medium and continuously reproduce the plurality of selected moving digital image data in accordance with the recorded reproduction information.

2. A digital image data recording and reproducing apparatus according to claim 1, wherein the reproduction information has indications that respectively represent the plurality of user selected still digital image data, and the indications are arranged in order of user selections.

3. A digital image data recording and reproducing apparatus according to claim 2, wherein the processor changes the recorded reproduction information in response to a user operation.

4. A digital image data recording and reproducing apparatus according to claim 3, wherein the plurality of still digital image data are displayed on an upper portion of the display unit, and the reproduction information is displayed on a lower portion of the display unit.
